(19) United States
(12) Patent Application Publication
(10) Pub. No.: US 2023/0125433 A1
(43) Pub. Date: Apr. 27, 2023

(54) CONFIDENCE AGGREGATION OF SCORE BASED ON CUSTOM MODELS BY FEATURE IMPORTANCE

(71) Applicant: HERE Global B.V., Eindhoven (NL)

(72) Inventors: Leon Stenneth, Chicago, IL (US); Hitesh Baid, Palghar (IN)

(21) Appl. No.: 17/512,141

(22) Filed: Oct. 27, 2021

(51) Int. Cl. B60W 60/00; G01C 21/00; G01C 21/34; G01C 21/36

(52) U.S. Cl. CPC B60W 60/0053; B60W 60/001; G01C 21/34; G01C 21/38; G01C 21/3626; B60W 2552/00

(57) ABSTRACT

Processors determine one or more aggregate confidence scores for a road segment; and based at least in part on the confidence score, determine a map-enabled driving scenario for a road segment. Determining the confidence score for the road segment comprises obtaining feature weights corresponding to road segment characteristics associated with the road segment; obtaining feature data associated with features along the road segment; based on the feature weights, and the feature data, defining continuous parameter range intervals along the road segment; assigning a respective interval confidence score to each continuous parameter range interval along the road segment based on a respective most relevant feature present in that interval; and determining the one or more aggregate confidence scores for the road segment based at least in part on each of the respective interval confidence scores.

### TECHNOLOGICAL FIELD

An example embodiment relates generally to determining a confidence score for a road segment. An example embodiment relates generally to determining one or more appropriate driving scenarios for a road segment based on a confidence score for the road segment.

### BACKGROUND

Global Navigation Satellite System (GNSS) based positions are typically accurate within 5 meters under open skies. However, this level of accuracy is not sufficient to enable autonomous, self-driving vehicles to effectively navigate roadways. Autonomous, self-driving vehicles and vehicles with advanced driver assistance systems (ADAS) tend to use detection of features along the road (e.g., detected in various forms of captured data) to aid in localization of the vehicle. Various embodiments relate to methods, systems, apparatuses, and/or computer program products relating to determining whether features along a road segment are sufficiently well modeled (e.g., by a digital map) to enable autonomous driving along the road segment.

### BRIEF SUMMARY OF SOME EXAMPLE EMBODIMENTS

Various embodiments are directed to determining one or more appropriate driving scenarios for a road segment based on a confidence score for the road segment. In various embodiments the confidence score for the road segment is determined by aggregating feature confidence scores for features located along the road segment based on the importance of the feature types and/or confidence score types for vehicle navigation along the road segment. In various embodiments, the importance of the feature types and/or confidence score types for vehicle navigation along the road segment is determined based at least in part on feature weights of a model corresponding to one or more road segment characteristics, such as at least one of a road functional class or a geographic setting associated with the road segment.

In various embodiments, one or more processors determine one or more aggregate confidence scores for a road segment and, based at least in part on the confidence score, determine a map-enabled driving scenario for the road segment. Determining the confidence score for the road segment comprises obtaining feature weights corresponding to one or more characteristics of the road segment, wherein a respective feature weight (a) is associated with at least one of a respective feature type or a respective confidence type and (b) indicates a relevancy measure of the associated respective feature type; obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located; based on (a) the respective parameter range indicator and the respective feature type of each instance of feature data and (b) the feature weights, defining continuous parameter range intervals along the road segment; assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and determining the one or more aggregate confidence scores for the road segment based at least in part on each of the respective interval confidence scores.

According to one aspect, a method for determining one or more map-enabled driving scenarios is provided. In an example embodiment, the method comprises determining, by one or more processors, one or more aggregate confidence scores for a road segment; and based at least in part on the confidence score, determining, by one or more processors, a map-enabled driving scenario for the road segment. Determining the confidence score for the road segment comprises obtaining feature weights corresponding to one or more characteristics of the road segment, wherein a respective feature weight (a) is associated with at least one of a respective feature type or a respective confidence type and (b) indicates a relevancy measure of the associated respective feature type; obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located; based on (a) the respective parameter range indicator and the respective feature type of each instance of feature data and (b) the feature weights, defining continuous parameter range intervals along the road segment; assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and determining the one or more aggregate confidence scores for the road segment based at least in part on each of the respective interval confidence scores.

In an example embodiment, the map-enabled driving scenario for the road segment indicates at least one of (a) whether autonomous vehicle operation is enabled along the road segment or (b) a level of autonomous vehicle operation that is enabled along the road segment.

In an example embodiment, assigning the respective interval confidence score to each continuous parameter range interval along the road segment comprises identifying one or more instances of feature data each comprising a respective parameter range indicator associated with the respective continuous parameter range interval; determining, based at least in part on (a) the feature weights and (b) at least one of the respective confidence type or the respective feature type of the one or more instances of feature data, the most relevant feature associated with the respective continuous parameter range interval; and determining, based on the at least one confidence score associated with the most relevant feature, the respective interval confidence score.

In an example embodiment, determining the most relevant feature associated with the respective continuous parameter range interval comprises determining a relevancy measure for the respective features located within the respective continuous parameter range interval.

In an example embodiment, the road segment type is determined based at least in part on at least one of (a) a road functional class associated with the road segment or (b) a geographic setting associated with the road segment.

In an example embodiment, the feature weights are determined by at least one of (a) a machine learning trained model or (b) user input.

In an example embodiment, the method further comprises causing a corresponding vehicle to be operated along at least a portion of the road segment in accordance with the map-enabled driving scenario.

In an example embodiment, the method further comprises causing a user interface to visually or audibly provide an indication of the map-enabled driving scenario.

In another aspect, an apparatus (e.g., a network apparatus and/or a mobile apparatus) is provided. In an example embodiment, the apparatus comprises at least one processor, a communications interface configured for communicating via at least one network, and at least one memory storing computer program code. The at least one memory and the computer program code are configured to, with the processor, cause the apparatus to at least determine one or more aggregate confidence scores for a road segment; and based at least in part on the confidence score, determine a map-enabled driving scenario for the road segment. Determining the confidence score for the road segment comprises obtaining feature weights corresponding to one or more characteristics of the road segment, wherein a respective feature weight (a) is associated with at least one of a respective feature type or a respective confidence type and (b) indicates a relevancy measure of the associated respective feature type; obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located; based on (a) the respective parameter range indicator and the respective feature type of each instance of feature data and (b) the feature weights, defining continuous parameter range intervals along the road segment; assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and determining the one or more aggregate confidence scores for the road segment based at least in part on each of the respective interval confidence scores.

In an example embodiment, the map-enabled driving scenario for the road segment indicates at least one of (a) whether autonomous vehicle operation is enabled along the road segment or (b) a level of autonomous vehicle operation that is enabled along the road segment.

In an example embodiment, assigning the respective interval confidence score to each continuous parameter range interval along the road segment comprises identifying one or more instances of feature data each comprising a respective parameter range indicator associated with the respective continuous parameter range interval; determining, based at least in part on (a) the feature weights and (b) at least one of the respective confidence type or the respective feature type of the one or more instances of feature data, the most relevant feature associated with the respective continuous parameter range interval; and determining, based on the at least one confidence score associated with the most relevant feature, the respective interval confidence score.

In an example embodiment, determining the most relevant feature associated with the respective continuous parameter range interval comprises determining a relevancy measure for the respective features located within the respective continuous parameter range interval.

In an example embodiment, the road segment type is determined based at least in part on at least one of (a) a road functional class associated with the road segment or (b) a geographic setting associated with the road segment.

In an example embodiment, the feature weights are determined by at least one of (a) a machine learning trained model or (b) user input.

In an example embodiment, the at least one memory and the computer program code are further configured to, with the processor, cause the apparatus to at least cause a corresponding vehicle to be operated along at least a portion of the road segment in accordance with the map-enabled driving scenario.

In an example embodiment, the at least one memory and the computer program code are further configured to, with the processor, cause the apparatus to at least cause a user interface to visually or audibly provide an indication of the map-enabled driving scenario.

In yet another aspect, a computer program product is provided that comprises at least one non-transitory computer-readable storage medium having computer-executable program code instructions stored therein. The computer-executable program code instructions comprise program code instructions that are configured, when executed by a processor of an apparatus, to cause the apparatus to determine one or more aggregate confidence scores for a road segment; and based at least in part on the confidence score, determine a map-enabled driving scenario for the road segment. Determining the confidence score for the road segment comprises obtaining feature weights corresponding to one or more characteristics of the road segment, wherein a respective feature weight (a) is associated with at least one of a respective feature type or a respective confidence type and (b) indicates a relevancy measure of the associated respective feature type; obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located; based on (a) the respective parameter range indicator and the respective feature type of each instance of feature data and (b) the feature weights, defining continuous parameter range intervals along the road segment; assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and determining the one or more aggregate confidence scores for the road segment based at least in part on each of the respective interval confidence scores.

In an example embodiment, the map-enabled driving scenario for the road segment indicates at least one of (a) whether autonomous vehicle operation is enabled along the road segment or (b) a level of autonomous vehicle operation that is enabled along the road segment.

In an example embodiment, assigning the respective interval confidence score to each continuous parameter range interval along the road segment comprises identifying one or more instances of feature data each comprising a respective parameter range indicator associated with the respective continuous parameter range interval; determining, based at least in part on (a) the feature weights and (b) at least one of the respective confidence type or the respective feature type of the one or more instances of feature data, the most relevant feature associated with the respective continuous parameter range interval; and determining, based on the at least one confidence score associated with the most relevant feature, the respective interval confidence score.

In an example embodiment, determining the most relevant feature associated with the respective continuous parameter range interval comprises determining a relevancy measure for the respective features located within the respective continuous parameter range interval.

In an example embodiment, the road segment type is determined based at least in part on at least one of (a) a road functional class associated with the road segment or (b) a geographic setting associated with the road segment.

In an example embodiment, the feature weights are determined by at least one of (a) a machine learning trained model or (b) user input.

In an example embodiment, the computer-executable program code instructions comprise program code instructions that are further configured, when executed by a processor of an apparatus, to cause the apparatus to cause a corresponding vehicle to be operated along at least a portion of the road segment in accordance with the map-enabled driving scenario.

In an example embodiment, the computer-executable program code instructions comprise program code instructions that are further configured, when executed by a processor of an apparatus, to cause the apparatus to cause a user interface to visually or audibly provide an indication of the map-enabled driving scenario.

In accordance with still another aspect, an apparatus is provided. In an example embodiment, the apparatus comprises means for determining one or more aggregate confidence scores for a road segment. The apparatus comprises means for, based at least in part on the confidence score, determining a map-enabled driving scenario for the road segment. Determining the confidence score for the road segment comprises obtaining feature weights corresponding to one or more characteristics of the road segment, wherein a respective feature weight (a) is associated with at least one of a respective feature type or a respective confidence type and (b) indicates a relevancy measure of the associated respective feature type; obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located; based on (a) the respective parameter range indicator and the respective feature type of each instance of feature data and (b) the feature weights, defining continuous parameter range intervals along the road segment; assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and determining the one or more aggregate confidence scores for the road segment based at least in part on each of the respective interval confidence scores.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of one embodiment of the present invention;

FIG. 2A is a block diagram of a network apparatus that may be specifically configured in accordance with an example embodiment;

FIG. 2B is a block diagram of a mobile apparatus that may be specifically configured in accordance with an example embodiment;

FIG. 3 is a flowchart illustrating operations performed, such as by the network apparatus of FIG. 2A and/or the mobile apparatus of FIG. 2B, to determine and use a map-enabled driving scenario for a road segment, in accordance with an example embodiment;

FIG. 4 is a flowchart illustrating operations performed, such as by the network apparatus of FIG. 2A and/or the mobile apparatus of FIG. 2B, to determine an aggregate confidence score for a road segment, in accordance with an example embodiment;

FIG. 5 is a schematic diagram illustrating an example road segment and the location of various features along the example road segment, in accordance with an example embodiment;

FIG. 6 is a flowchart illustrating operations performed, such as by the network apparatus of FIG. 2A and/or the mobile apparatus of FIG. 2B, to define continuous parameter range intervals along the road segment, in accordance with an example embodiment;

FIG. 7 provides a table illustrating at least a portion of feature data associated with the various features along the example road segment shown in FIG. 5, in accordance with an example embodiment;

FIG. 8 provides a table illustrating the discretized parameter ranges along the road segment and the features associated with each of the respective discretized parameter ranges for the feature data shown in FIG. 7, in accordance with an example embodiment;

FIG. 9 provides a table illustrating the most relevant feature associated with each respective discretized parameter range shown in FIG. 8, in accordance with an example embodiment; and

FIG. 10 provides a table illustrating the continuous parameter range intervals compiled from the discretized parameter ranges shown in FIG. 9, in accordance with an example embodiment.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

### I. General Overview

Methods, apparatus, systems, and computer program products are provided in accordance with an example embodiment to determine a map-enabled driving scenario for a road segment based on one or more aggregate confidence scores for the road segment. Various embodiments provide methods, apparatus, systems, and/or computer program products for determining one or more aggregate confidence scores for a road segment based feature data associated with features of a digital map that model and/or represent real world objects located along the road segment. In various embodiments, the aggregate confidence scores are determined based on the importance of various feature types and/or confidence score types for vehicle navigation along the road segment. In various embodiments, the importance of the various feature types and/or confidence score types for vehicle navigation along the road segment is determined based at least in part on feature weights of a model corresponding to one or more characteristics of the road segment. In various embodiments, the one or more characteristics of the road segment comprise at least one of a road functional class or a geographic setting associated with the road segment. For example, the road functional class of a road segment may be interstate, freeway, highway, arterial, collector, residential, local, and/or the like, in various embodiments. For example, the geographic setting of a road segment may reflect the topology of the geographical area where the road segment is located (e.g., mountainous, hilly, flat, and/or the like), a context of the road segment (e.g., urban, suburban, rural), and/or the like. In various embodiments, the model may be situational and correspond to a specific time of day (e.g., dawn, daylight hours, dusk, night time and/or the like), a specific type of weather (e.g., sunny, cloudy, rainy, foggy, snowy, and/or the like), ranges of traffic volume (e.g., light traffic, medium traffic, heavy traffic), and/or other time variable situational categories.

In various embodiments, determination of the map-enabled driving scenarios is determined based on feature data that is stored as part of a digital map. In various embodiments, a vehicle is operated along at least a portion of the road segment in accordance with the determined map-enabled driving scenario(s) for the road segment. In an example embodiment, the determined map-enabled driving scenario(s) for the road segment may be visually and/or audibly provided via a user interface, stored to a database for accessing at a later time, and/or the like.

In various embodiments, the map-enabled driving scenario for the road segment indicates whether autonomous vehicle operation and/or ADAS is enabled by for the road segment. In various embodiments, the map-enabled driving scenario for the road segment indicates one or more map-enabled levels of driving automation (e.g., the highest map-enabled level, a range of map-enabled levels, and/or the like) for the road segment. In general, the zeroth level of driving automation corresponds to full manual control and the complete absence of automation. The first level of driving automation corresponds to a single automated feature, such as automated monitoring of speed through cruise control, for example. The second level of driving automation, sometimes referred to as ADAS, corresponds to partial automation of vehicle control where steering and acceleration are automated but the human operator still monitors all tasks and can take control at any time. The third level of driving automation, also referred to as conditional automation, includes automated environmental detection and automated performance of most tasks. However, human override is still required. The fourth level of driving automation, also referred to high automation, allows the automated operation of the vehicle under specific circumstances. However geofencing may be required and human override is still an option. The fifth level of driving automation, also referred to as full automation, includes complete automated control of the vehicle under all conditions with zero human interaction and/or attention required.

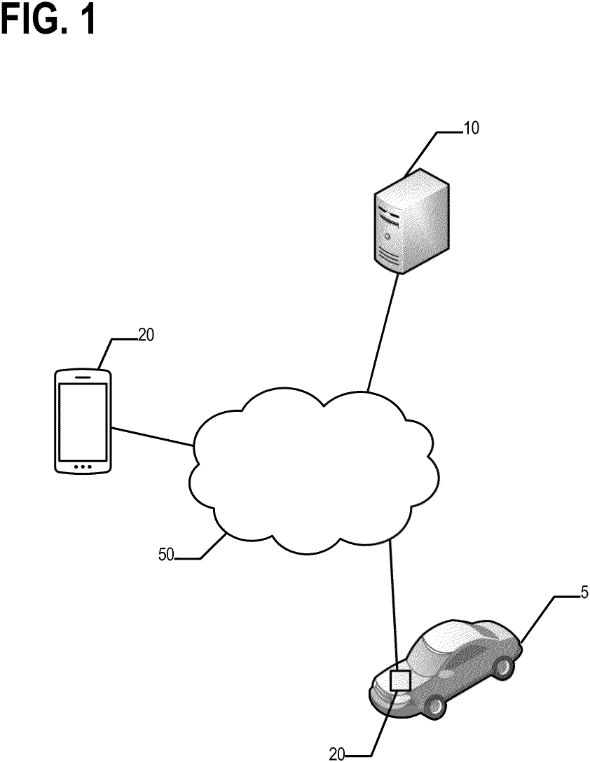

FIG. 1 provides an illustration of an example system that can be used in conjunction with various embodiments of the present invention. As shown in FIG. 1, the system may include one or more network apparatuses 10, one or more mobile apparatuses 20, one or more networks 50, and/or the like.

In various embodiments, the mobile apparatus 20 may be an in vehicle navigation system, vehicle control system, a mobile computing device, user device such as a smartphone or table, and/or the like. For example, a mobile apparatus 20 may be an in vehicle navigation system mounted within and/or be onboard a vehicle 5 such as a motor vehicle, non-motor vehicle, automobile, car, scooter, truck, van, bus, motorcycle, bicycle, Segway, golf cart, and/or the like. In an example embodiment, the mobile apparatus 20 may be a vehicle control system configured to autonomously drive a vehicle 5, assist in control of a vehicle 5, monitor various aspects of the vehicle 5 (e.g., fault conditions, motor oil status, battery charge level, fuel tank fill level, environment, and/or the like) and/or the like. In various embodiments, a mobile apparatus 20 configured to autonomously drive a vehicle 5 may perform multiple functions that are similar to those performed by a mobile apparatus configured to be an ADAS (e.g., lane keeping, lane change assistance, maintaining a lane, merging, etc.). In some embodiments, a mobile apparatus 20 may be onboard a personal vehicle, commercial vehicle, public transportation vehicle, fleet vehicle, and/or other vehicle. In various embodiments, the mobile apparatus 20 may be a smartphone, tablet, personal digital assistant (PDA), personal computer, desktop computer, laptop, and/or other mobile computing device.

In an example embodiment, the network apparatus 10 may be a server, group of servers, distributed computing system, and/or other computing system. For example, the network apparatus 10 may be in communication with one or more mobile apparatuses 20, and/or the like via one or more wired or wireless networks 50. While the network apparatus 10 is generally described herein as a single computing entity, in various embodiments, the functions described herein as being performed by the network apparatus 10 may be performed by one or more of multiple network apparatuses 10.

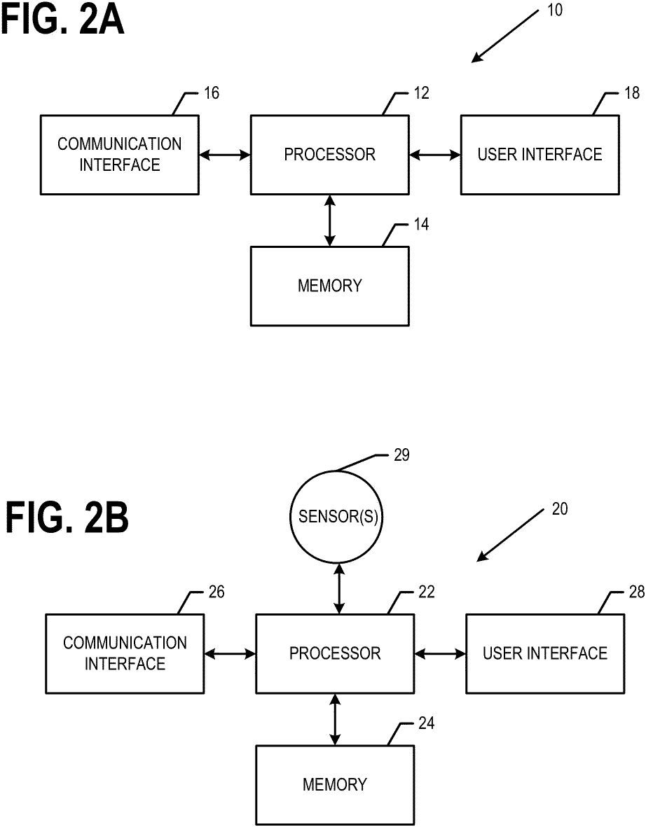

In an example embodiment, a network apparatus 10 may comprise components similar to those shown in the example network apparatus 10 diagrammed in FIG. 2A. In an example embodiment, the network apparatus 10 is configured to determine and/or generate one or more models specific to one or more road segment characteristics, use feature data of a digital map to determine one or more aggregate confidence scores for one or more road segments based on respective models specific to one or more road segment characteristics associated with the respective road segments, use the one or more aggregate confidence scores to determine one or more respective map-enabled driving scenarios for the one or more road segments, provide and/or output the determined one or more respective map-enabled driving scenarios for the one or more road segments, cause one or more vehicles to be operated in accordance with the determined one or more respective map-enabled driving scenarios along the respective road segments, and/or the like. For example, as shown in FIG. 2A, the network apparatus 10 may comprise a processor 12, memory 14, a user interface 18, a communications interface 16, and/or other components configured to perform various operations, procedures, functions or the like described herein. In at least some example embodiments, the memory 14 is non-transitory.

In an example embodiment, a mobile apparatus 20 is onboard a vehicle 5, a user device, and/or a mobile computing entity. In an example embodiment, the mobile apparatus 20 may be configured to provide navigation and/or route information/data to a user (e.g., an operator of the vehicle 5) and/or configured to autonomously drive a vehicle 5 and/or assist in control of a vehicle 5 (e.g., an ADAS) in accordance with navigation and/or route information/data. In an example embodiment, the mobile apparatus 20 may be configured to use feature data of a digital map to determine one or more aggregate confidence scores for one or more road segments based on respective models specific to one or more road segment characteristics associated with the respective road segments, use the one or more aggregate confidence scores to determine one or more respective map-enabled driving scenarios for the one or more road segments, provide and/or output the determined one or more respective map-enabled driving scenarios for the one or more road segments, cause one or more vehicles to be operated in accordance with the determined one or more respective map-enabled driving scenarios along the respective road segments, and/or the like.

In an example embodiment, as shown in FIG. 2B, the mobile apparatus 20 may comprise a processor 22, memory 24, a communications interface 26, a user interface 28, one or more sensors 29 (e.g., a location sensor such as a global navigation satellite system (GNSS) sensor; inertial measurement unit (IMU) sensors; camera(s); two dimensional (2D) and/or three dimensional (3D) light detection and ranging (LiDAR)(s); long, medium, and/or short range radio detection and ranging (RADAR); ultrasonic sensors; electromagnetic sensors; (near-) infrared (IR) cameras; 3D cameras; 360° cameras; fuel level sensors; vehicle system sensors (e.g., oil status sensors, tire pressure sensors, engine oil pressure sensors, coolant level sensors, engine/coolant temperature sensors, and/or other sensors that enable the mobile apparatus 20 to determine one or more features of the corresponding vehicle’s 5 surroundings and/or monitor the vehicle’s 5 operating parameters), and/or other components configured to perform various operations, procedures, functions or the like described herein. In at least some example embodiments, the memory 24 is non-transitory.

Each of the components of the system may be in electronic communication with, for example, one another over the same or different wireless or wired networks 50 including, for example, a wired or wireless Personal Area Network (PAN), Local Area Network (LAN), Metropolitan Area Network (MAN), Wide Area Network (WAN), cellular network, and/or the like. In some embodiments, a network 50 may comprise the automotive cloud, digital transportation infrastructure (DTI), radio data system (RDS)/ high definition (HD) radio or other digital radio system, and/or the like. For example, a mobile apparatus 20 may be in communication with a network apparatus 10 via the network 50. For example, a mobile apparatus 20 may communicate with the network apparatus 10 via a network, such as the Cloud. For example, the Cloud may be a computer network that provides shared computer processing resources and data to computers and other devices connected thereto.

Certain example embodiments of the network apparatus 10 and mobile apparatus 20, are described in more detail below with respect to FIGS. 2A and 2B.

### II. Example Operation

Methods, apparatus, systems, and computer program products are provided in accordance with an example embodiment for determining a map-enabled driving scenario for a road segment based on one or more aggregate confidence scores for the road segment. Various embodiments provide methods, apparatus, systems, and/or computer program products for determining one or more aggregate confidence scores for a road segment based feature data associated with features of a digital map that model and/or represent real world objects located along the road segment.

For example, a network apparatus 10 and/or a mobile apparatus 20 may access feature data corresponding to features that model and/or represent real world objects located along a road segment and, based on the access feature data, determine one or more aggregate confidence scores for the road segment based at least in part on feature weights of a model corresponding to one or more road segment characteristics. The network apparatus 10 and/or mobile apparatus 20 may then determine one or more map-enabled driving scenarios for the road segment based on the determined one or more aggregate confidence scores.

### Example of Determining Map-Enabled Driving Scenario for a Road Segment Based on Aggregate Confidence Scores

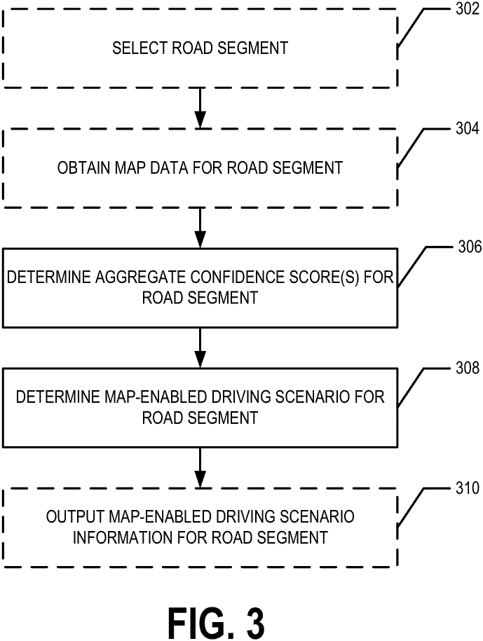

FIG. 3 provides a flowchart illustrating various processes, procedures, operations, and/or the like that may be performed (e.g., by a network apparatus 10 and/or mobile apparatus 20) to determine one or more map-enabled driving scenarios for a road segment. Starting at block 302, a road segment is selected. For example, the network apparatus 10 and/or mobile apparatus 20 selects and/or identifies a road segment for which the one or more map-enabled driving scenarios are to be determined. For example, the network apparatus 10 and/or mobile apparatus 20 may comprise means, such as processor 12, 22, memory 14, 24, and/or the like, for selecting and/or identifying a road segment for which the one or more map-enabled driving scenarios are to be determined.

In an example embodiment, the road segment is selected and/or identified based on a map traversal and/or map exploration algorithm. For example, a database, list, and/or the like of map-enabled driving scenarios for various road segments may be generated and road segments may be selected at random, based on a map traversal, and/or map exploration algorithm. In another example embodiment, a route for a vehicle 5 (and a corresponding mobile apparatus 20) to traverse may be determined and one or more road segments included in the route may be selected and/or identified for respective determination of the map-enabled driving scenarios for the respective road segments. For example, a user (e.g., operating a mobile device 20 via user interface 28) may indicate an origin location and/or a destination location for a trip and indicate that they want a particular level of automated operation of a vehicle to be enabled for the trip. As part of determining a route for the trip and/or responsive to determining a route for the trip, the road segments of the route may be selected and/or identified in turn and/or for batch determination of the respective map-enabled driving scenarios for the respective road segments. In another example, a vehicle 5 may be approaching a road segment according to a determined route and/or a predicted route of the vehicle 5, and the road segment being approached may be selected and/or identified for determination of the map-enabled driving scenarios of the road segment.

At block 304, map data is obtained and/or accessed for the road segment. For example, the network apparatus 10 and/or the mobile apparatus 20 may obtain and/or access map data for the road segment. For example, the network apparatus 10 and/or mobile apparatus 20 may comprise means, such as processor 12, 22, memory 14, 24, communication interface 16, 26, and/or the like, for obtaining map data for the road segment. For example, the network apparatus 10 and/or mobile apparatus 20 may store a digital map in memory 14, 24 and may access map data corresponding the road segment therefrom. In an example embodiment, the mobile apparatus 20 may request and receive map data corresponding to the road segment (e.g., from the network apparatus 10).

In various embodiments, the obtained and/or accessed map data comprises information indicating characteristics of the road segment. For example, the obtained and/or accessed map data may include a road functional class or a geographic setting associated with the road segment. For example, the road functional class of a road segment may be interstate, freeway, highway, arterial, collector, residential, local, and/or the like, in various embodiments. For example, the geographic setting of a road segment may reflect the topology of the geographical area where the road segment is located (e.g., mountainous, hilly, flat, and/or the like), a context of the road segment (e.g., urban, suburban, rural), a combination thereof, and/or the like. For example, the obtained and/or accessed map data may include the information needed to identify and/or access an appropriate model corresponding to the characteristics of the road segment such that appropriate feature weights may be accessed and/or obtained.

In various embodiments, the obtained and/or accessed map data comprises feature data corresponding to one or more features associated with the road segment. For example, the feature data corresponding to a feature may include a location and/or parameter range indicator corresponding to a location and/or range of locations along the road segment where a real world object that is modeled and/or represented by the feature is located. The feature is associated with the road segment when the location and/or parameter range indicator correspond to location(s) along the road segment. In various embodiments, the feature data associated with a feature comprises a confidence score and an associated confidence type, a feature type (e.g., speed sign, highway exit sign, lane marking, barrier, pole, and/or the like) indicating a type of the real world object modeled and/or represented by the feature, and/or the like.

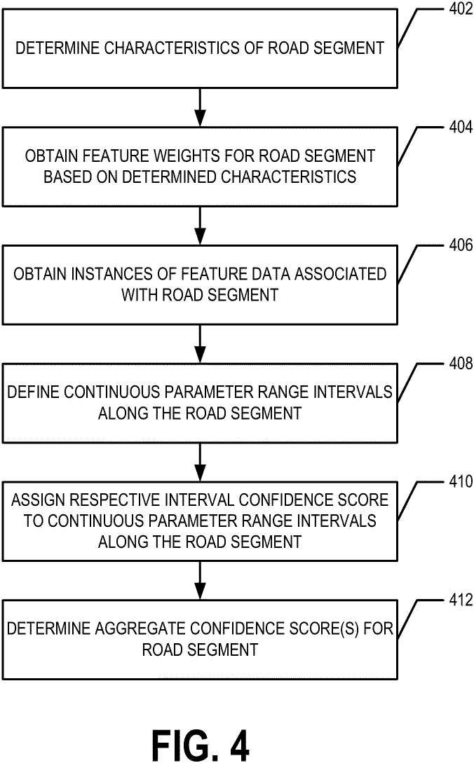

At block 306, one or more aggregate confidence score(s) are determined for the road segment. For example, the network apparatus 10 and/or the mobile apparatus 20 may determine one or more aggregate confidence score(s) for the road segment. For example, the network apparatus 10 and/or the mobile apparatus 20 may comprise means, such as processor 12, 22, memory 14, 24, and/or the like, for determining one or more aggregate confidence score(s) for the road segment. In various embodiments, the aggregate confidence score(s) for the road segment are determined based at least in part on the feature weights of the model corresponding to the one or more characteristics of the road segment and one or more confidence scores of the feature data associated with the road segment. For example, in an example embodiment, the aggregate confidence score(s) for the road segment is determined based at least in part on a confidence score corresponding to a feature having a most relevant feature type and/or confidence type indicated to be most relevant for the one or more characteristics of the road segment. An example of determining the aggregate confidence score(s) for the road segment is described with respect to FIG. 4.

At block 308, one or more map-enabled driving scenarios are determined for the road segment. For example, the network apparatus 10 and/or the mobile apparatus 20 determines one or more map-enabled driving scenarios for the road segment. For example, the network apparatus 10 and/or the mobile apparatus 20 comprises means, such as processor 12, 22, memory 14, 24, and/or the like, for determining one or more map-enabled driving scenarios for the road segment. In an example embodiment, the determined one or more driving scenarios is and/or comprises an indication of whether automated vehicle operation is enabled by the digital map for the road segment. In an example embodiment, the determined one or more driving scenarios is and/or comprises an indication of whether automated vehicle operation and/or ADAS operation is enabled by the digital map for the road segment. In an example embodiment, the determined one or more driving scenarios is and/or comprises an indication of the highest level of automated operation of a vehicle that is enabled by the map for the road segment. In an example embodiment, the determined one or more driving scenarios is and/or comprises an indication of a range of automated operation of a vehicle that is enabled by the map for the road segment.

In various embodiments, the one or more map-enabled driving scenarios for the road segment are determined based at least in part on the one or more aggregate confidence scores determined for the road segment. For example, one or more threshold requirements may be evaluated to determine whether automated vehicle operation is enabled by the digital map for the road segment, whether ADAS operation is enabled by the digital map for the road segment, a highest level of automated operation of a vehicle that is enabled by the digital map for the road segment, a range of levels of automated operation of a vehicle that is enabled by the digital map for the road segment, and/or the like. For example, in an example embodiment, the threshold requirements may include a respective threshold score associated with each level of automated operation of the vehicle. The threshold requirements are then evaluated by comparing the determined one or more aggregate confidence scores for the road segment to the threshold scores to determines which threshold requirements are satisfied. For example, in an example embodiment, a threshold requirement is satisfied when at least one of or each of the one or more aggregate confidence scores for the road segment are greater than the a corresponding threshold score.

At block 310, map-enabled driving scenario information is output. For example, the network apparatus 10 and/or mobile apparatus 20 outputs map-enabled driving scenario information. For example, the network apparatus 10 and/or mobile apparatus 20 comprises means, such as processor 12, 22, memory 14, 24, communication interface 16, 26, user interface 18, 28, and/or the like, for outputting map-enabled driving scenario information. In an example embodiment, the map-enabled driving scenario information identifies the road segment, the map version of the digital map used to determine the one or more aggregated confidence scores for the road segment, the one or more map-enabled driving scenarios for the road segment, and/or the like.

In various embodiments, the map-enabled driving scenario information is outputted to be stored in a database or other format of data storage. In various embodiments, the map-enabled driving scenario information is outputted visually and/or audibly via a user interface 18, 28 (e.g., display, speaker, and/or the like) such that a human user may be alerted to the map-enabled driving scenario for the road segment. In various embodiments, the map-enabled driving scenario information is provided via communication interface 18, 28. For example, the network apparatus 10 may determine the one or more map-enabled driving scenarios and provide (e.g., transmit) the map-enabled driving scenario information for receipt by the mobile apparatus 20. The mobile apparatus 20 may then operate a vehicle in accordance with and/or provide visual and/or audible indication of the one or more map-enabled driving scenarios for the road segment. In an example embodiment, outputting the map-enabled driving scenario information comprises causing one or more systems of a vehicle 5 to operate along at least a portion of the road segment in accordance with the one or more map-enabled driving scenarios.

For example, the network apparatus 10 may generate and provide (e.g., transmit) executable instructions that are configured to execution by a mobile apparatus 20 associated with the vehicle 5 such that execution of executable instructions by the mobile apparatus 20 causes the vehicle 5 to be operated along at least a portion of the road segment in accordance with the one or more map-enabled driving scenarios. In another example, the mobile apparatus 20 may control one or more systems of the vehicle 5 (e.g., acceleration and/or speed control system, steering system, lane maintenance system, and/or the like) in accordance with the one or more map-enabled driving scenarios along at least a portion of the road segment. For example, when the highest map-enabled level of automated operation of a vehicle along the road segment is the fourth level, the network apparatus 20 may cause (possibly responsive to executable instructions generated and/or provided by the network apparatus 10) one or more systems of the vehicle 5 to be operated at no high than the fourth level of automated operation of the vehicle along the road segment. For example, the network apparatus 20 may prevent the vehicle 5 from being operated at the fifth level of automated operation of the vehicle, but may permit or enable the vehicle 5 to be operated at the zeroth, first, second, third, or fourth level of automated operation of the vehicle along the road segment.

### Example of Determining Aggregate Confidence Score(s) for a Road Segment

As described above, the map-enabled driving scenario(s) for a road segment is determined based on one or more aggregate confidence scores for the road segment. The aggregate confidence score is determined based on feature data for features associated with the road segment and feature weights that indicate the importance of various feature types and/or confidence types for vehicle navigation along various road segments having one or more characteristics of the road segment. FIG. 4 provides a flowchart illustrating various processes, procedures, operations, and/or the like for determining the one or more aggregate confidence scores for the road segment. For example, block 306 may comprise the processes, procedures, operations, and/or the like detailed with respect to FIG. 4, in various embodiments. In various embodiments, the processes, procedures, operations, and/or the like shown in FIG. 4 are performed by the network apparatus 10 and/or mobile apparatus 20.

Starting at block 402, one or more characteristics of the road segment are determined. For example, the network apparatus 10 and/or the mobile apparatus 20 may determine one or more characteristics of the road segment. For example, the network apparatus 10 and/or mobile apparatus 20 may comprise means, such as processor 12, 22, memory 14, 24, and/or the like for determining one or more characteristics of the road segment.

For example, the map data corresponding to the road segment obtained at block 304 may be used to determine one or more characteristics of the road segment. In various embodiments, the one or more characteristics of the road segment comprises a road functional class. For example, the map data corresponding to the road segment may comprise a road functional class indicator configured to indicate the road functional class corresponding to and/or assigned to the road segment. For example, the road functional class of a road segment may be interstate, freeway, highway, arterial, collector, residential, local, and/or the like. In various embodiments, the one or more characteristics of the road segment comprises a geographic setting associated with the road segment. For example, the map data corresponding to the road segment may comprise information that can be used to determine a geographic setting for the road segment. For example, the geographic setting of a road segment may reflect the topology of the geographical area where the road segment is located (e.g., mountainous, hilly, flat, and/or the like), the topology of the road segment itself (e.g., very curvy, moderately curvy, moderately straight, straight, and/or the like), a context of the road segment (e.g., urban, suburban, rural), and/or the like.

At block 404, an appropriate model is identified based at least in part on the one or more characteristics of the road segment and the corresponding feature weights are accessed. For example, the network apparatus 10 and/or mobile apparatus 20 identifies an appropriate model based at least in part on the one or more characteristics of the road segment and accesses the feature weights corresponding to the identified model. For example, the network apparatus 10 and/or the mobile apparatus 20 comprises means, such as processor 12, 22, memory 14, 24, communications interface 16, 26, and/or the like for identifying an appropriate model based at least in part on the one or more characteristics of the road segment and accessing the feature weights corresponding to the identified model.

The feature weights and meta data indicating the associated characteristics are stored (e.g., in memory 14, 24) for use future access and/or use. In various embodiments, the model may be situational and correspond to a specific time of day (e.g., dawn, daylight hours, dusk, night time and/or the like), a specific type of weather (e.g., sunny, cloudy, rainy, foggy, snowy, and/or the like), ranges of traffic volume (e.g., light traffic, medium traffic, heavy traffic), and/or other time variable situational categories. Thus, the meta data may also indicate one or more situations to which the model pertains.

In an example embodiment, the model is generated based on user input (e.g., via a user interface 18, 28) indicating feature weights assigned to one or more feature types, confidence types, feature type and confidence type combinations, and/or the like. In various embodiments, the features weights correspond to certain types, brands, models, and/or the like of sensors 29 (e.g., as indicated by the meta data associated with the respective models) and the feature weights are defined (e.g., based on user input received via user interface 18, 28) to reflect known response characteristics and/or behaviors of the sensors 29 (e.g., some objects may be more reliably detected by the sensors and/or within sensor data captured by the sensors than others). In various embodiments, the feature weights are defined (e.g., based on user input received via user interface 18, 28) based on a known and/or observed object type frequency (e.g., how many such objects are usually visible along a road segment of a particular road functional class, in a particular geographic setting, and/or the like). In various embodiments, the feature weights are defined (e.g., based on user input received via user interface 18, 28) based on object distinctiveness (e.g., how easily a particular type of object can be differentiated from other objects and/or from the background). In various embodiments, the feature weights can be manipulated and/or modified (e.g., based on user input received via user interface 18, 28) in order to improve the reliability of the resulting aggregate confidence score(s) and/or determined map-enabled driving scenario(s).

In an example embodiment, the model is generated by a machine learning trained engine. For example, training data indicating which types of features and/or which elements of various types of features detected by a vehicle were used and/or how different types of features and/or which elements of various types of features detected by the vehicle were used when traversing various road segments of a particular set of characteristics and/or under particular situations may be used to train a machine learning trained engine that then generates a model corresponding to the particular set of characteristics and/or particular situations. In various embodiments, the machine learning trained engine is a classifier, deep neural network, artificial neural network, recurrent neural network, convolutional neural network, and/or the like.

In various embodiments, the feature weights indicate the importance of a feature of a particular feature type and/or a confidence type when a vehicle is traversing a road segment having the particular characteristics and/or under the particular situation. For example, the feature weights indicate how relevant a feature of a particular feature type or having a particular confidence type is performing vehicle localization, for example, as the vehicle traverses a road segment of the particular characteristics and/or under the particular situation. For example, when traversing a highway road segment, a pole, such as a street light pole, may be less helpful or provide a data point of less significance for vehicle navigation (e.g., vehicle navigation using automated operation of the vehicle) compared to a highway exit sign or a lane marking. In another example, a traffic light pole may be more helpful or provide a data point of higher significance for vehicle navigation (e.g., vehicle navigation using automated operation of the vehicle) compared to an exit sign or speed limit sign when traversing a local urban road segment.

Continuing to block 406, feature data associated with the road segment is obtained. In an example embodiment, the feature data associated with the road segment is obtained (e.g., accessed, read, requested and received, and/or the like) at block 304. In an example embodiment, the network apparatus 10 and/or the mobile apparatus 20 obtains feature data associated with the road segment. For example, the network apparatus 10 and/or the mobile apparatus 20 comprise means, such as processor 12, 22, memory 14, 24, communication interface 16, 26, and/or the like, for obtaining feature data associated with the road segment. In an example embodiment, the feature data is accessed and/or read from the digital map. For example, the digital map may comprise a feature layer and/or localization layer comprising feature data.

In various embodiments, the feature data corresponding to a feature include a location and/or parameter range indicator corresponding to a location and/or range of locations along the road segment where a real world object that is modeled and/or represented by the feature is located. In an example embodiment, the parameter range indicator is configured to indicates a normalized location or range of possible locations where the feature is located along the road segment. The feature is associated with the road segment when the location and/or parameter range indicator correspond to location(s) along the road segment. In an example embodiment, the feature data corresponding to a feature comprises a road segment identifier configured to identify the associated road segment. In various embodiments, the feature data associated with a feature comprises a confidence score and an associated confidence type (e.g., existence, classification, location), a feature type (e.g., speed sign, highway exit sign, lane marking, barrier, pole, and/or the like) indicating a type of the real world object modeled and/or represented by the feature, and/or the like. For example, a confidence score associated with the confidence type existence may indicate the confidence with each the existence of the feature within the indicated parameter range is known. In another example, a confidence score associated with the confidence type classification may indicate the confidence with which the classification of the feature is known. For example, a confidence score associated with the confidence score location may indicate the confidence with which the location of the feature is known.

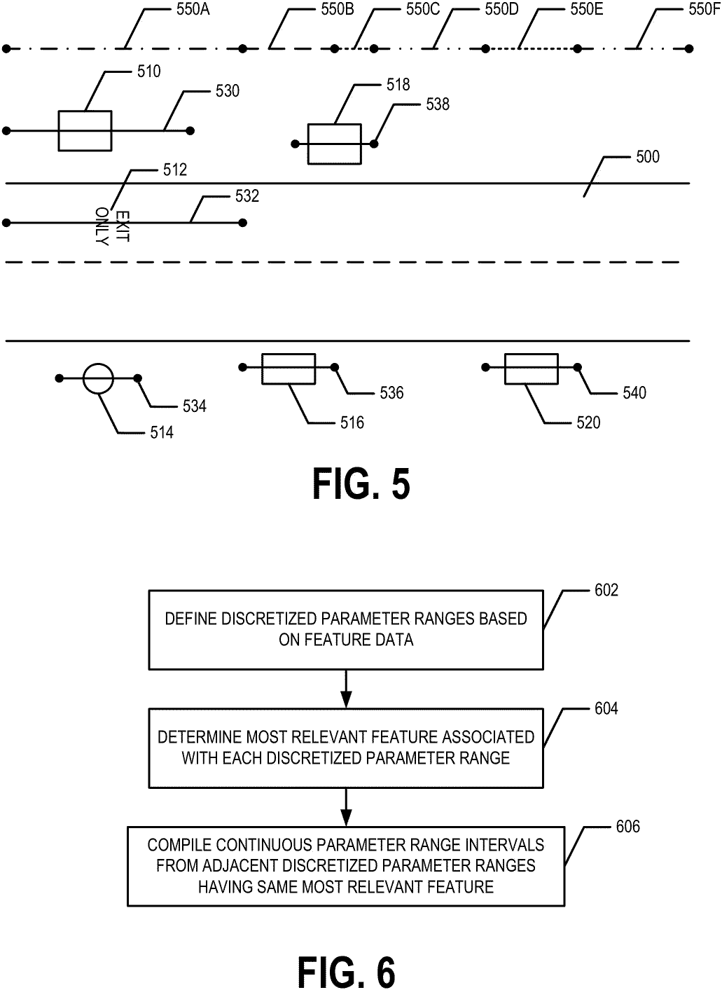

At block 408, continuous parameter range intervals are defined along the road segment based at least in part on the feature data and the feature weights. For example, FIG. 5 illustrates a road segment 500 and the continuous parameter range intervals 550 (e.g., 550A, 550B, 550C, 550D, 550E, 550F) defined along the road segment based on the parameter ranges 530, 532, 534, 536, 538, 540 each associated with a respective one of the features 510, 512, 514, 516, 518, 520 along the road segment. For example, the network apparatus 10 and/or the mobile apparatus 20 defines continuous parameter range intervals along the road segment based at least in part on the feature data and the feature weights. For example, the network apparatus 10 and/or the mobile apparatus 20 comprises means, such as processor 12, 22, memory 14, 24, and/or the like for defining continuous parameter range intervals along the road segment based at least in part on the feature data and the feature weights. The continuous parameter range intervals are continuous in the that each interval of parameter ranges is a continuous interval and that, when combined (as shown in FIG. 5) the sum of the continuous parameter range intervals is the length of the road segment. In various embodiments, the continuous parameter range intervals are defined, at least in part by identifying the most important features for each portion of the road features (e.g., based on the feature weights and feature types and/or confidence types of the feature data). In various embodiments, each continuous parameter range interval is defined based on such that the interval confidence score assigned to the interval corresponds to a most important or most relevant feature (e.g., based on feature type and/or confidence type of the feature data corresponding to the feature) for the interval. The most important and/or most relevant feature for a continuous parameter range interval is associated with the whole of the continuous parameter range interval (e.g., the parameter range of the feature includes the entire continuous parameter range interval). An example of defining continuous parameter range intervals is described in more detail with respect to FIG. 6.

At block 410, a respective interval confidence score is assigned to each continuous parameter range interval. For example, the network apparatus 10 and/or mobile apparatus 20 assigns a respective interval confidence score to each continuous parameter range interval. For example, the network apparats 10 and/or mobile apparatus 20 comprises means, such as processor 12, 22, memory 14, 24, and/or the like for assigning a respective interval confidence score to each continuous parameter range interval.

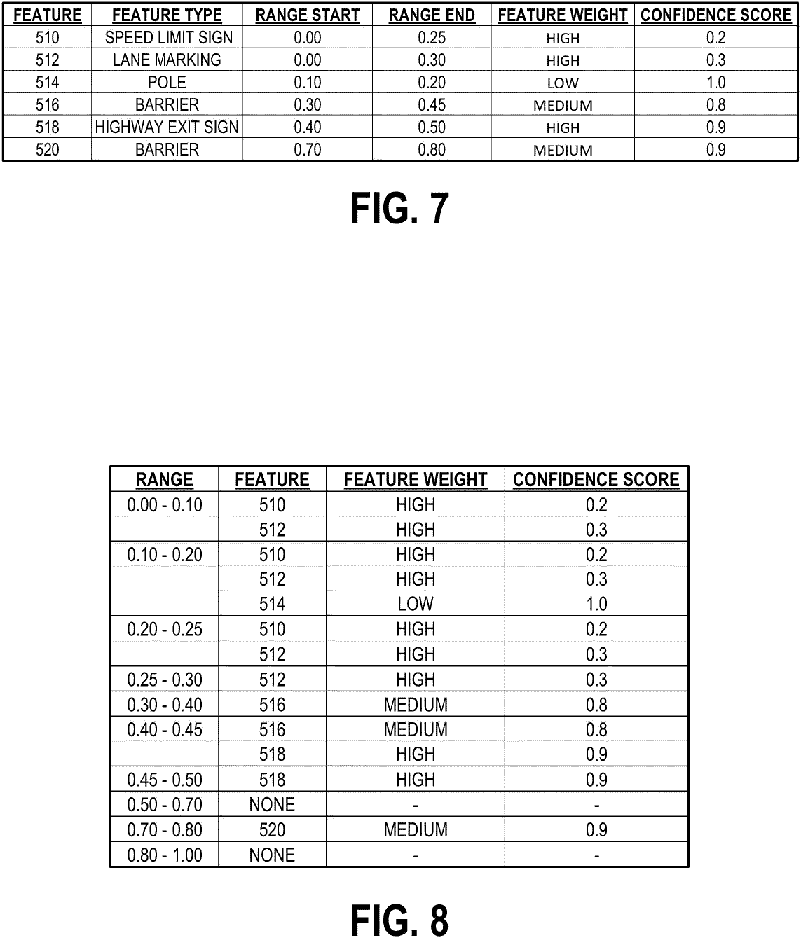

For example, the interval confidence score assigned to a particular continuous parameter range interval is determined based at least in part on the confidence score assigned to the most important or more relevant feature corresponding to (e.g., located within and/or having a parameter range that includes the continuous parameter range interval) the continuous parameter range interval. For example, the feature weights are used to determine which feature is most important and/or most relevant for each continuous parameter range interval. For example, six features 510, 512, 514, 516, 518, and 520 are located along the road segment shown in FIG. 5 and are associated with the respective parameter ranges 530, 532, 534, 536, 538, and 540, as shown in the table provided by FIG. 7. As shown in FIG. 7, the feature 510 corresponds to a speed limit sign (e.g., has feature type speed limit sign), the feature 512 corresponds to a lane marking (e.g., has feature type lane marking), and the feature 518 corresponds to a highway exit sign (e.g., has feature type highway exit sign). Features 516, 518 correspond to highway barriers (e.g., have feature type highway barrier) and feature 514 corresponds to a pole (e.g., has feature type pole like object). As the road segment is of the road functional class highway, the feature weights indicate that features 510, 512, and 518 are more important and/or more relevant to automated operation of a vehicle along the road segment 500 than features 516, 518 (which are more important and/or more relevant to automated operation of a vehicle along the road segment 500 than feature 514).

When two or more features within a continuous parameter range interval have the same feature weight, the relative importance of the and/or relative relevance of the two or more features is determined based on the values of the confidence scores. For example, the assigned confidence score is that of the highest confidence score of the most important and/or most relevant features in the continuous parameter range interval, in an example embodiment. For example, a first feature having a particular feature weight and a first confidence score is determined to be more important and/or more relevant in a common continuous parameter range interval than a second feature having the particular feature weight and a second confidence score when the first confidence score is greater than the second confidence score.

Continuing to block 412 of FIG. 4, one or more aggregate confidence scores are determined for the road segment based at least in part on the interval confidence scores. For example, the network apparatus 10 and/or mobile apparatus 20 determines one or more aggregate confidence scores for the road segment based at least in part on the interval confidence scores . For example, the network apparatus 10 and/or mobile apparatus 20 comprises means, such as processor 12, 22, memory 14, 24, and/or the like for determining one or more aggregate confidence scores for the road segment based at least in part on the interval confidence scores.

For example, in an example embodiment, the one or more aggregate confidence scores are the interval confidence scores. In an example embodiment, the one or more aggregate confidence scores are a single confidence score that is the weighted average of the interval confidence scores. For example, the weights used to determine the weighted average may be based on the percentage and/or fraction of the length of the road segment that the continuous parameter range interval to which an interval confidence range is assigned. For example, for the interval confidence scores shown in FIG. 10, the aggregate confidence score determined based on a weighted average of the interval confidence scores may be 0.35. Various techniques may be used to determine one or more aggregate confidence scores for the road segment based on the interval confidence scores, as appropriate for the application.

### Example of Defining Continuous Parameter Range Intervals

As described above, the determining of the aggregate confidence score(s) for a road segment comprises defining continuous parameter range intervals along the road segment based at least in part on the obtained feature weights and the feature data corresponding to features along the road segment. FIG. 6 provides a flowchart illustrating various processes, procedures, operations, and/or the like for defining continuous parameter range intervals along the road segment, according to various embodiments. For example, block 408 may comprise the processes, procedures, operations, and/or the like detailed with respect to FIG. 6, in various embodiments. In various embodiments, the processes, procedures, operations, and/or the like shown in FIG. 6 are performed by the network apparatus 10 and/or mobile apparatus 20. FIG. 5 provides a schematic diagram of features 510, 512, 514, 516, 518, 520 located along a road segment 500 (e.g., at respective parameter ranges 530, 532, 534, 536, 538, 540). In the illustrated embodiment, road segment 500 has the characteristic of road functional class highway. FIG. 7 provides a table describing the features shown in FIG. 5 and FIGS. 8, 9, and 10 provide tables depicting various steps of the flowchart shown in FIG. 6 based on the example road segment 500 illustrated in FIG. 5 and having the features 510, 512, 514, 516, 518, 520 located there along as described in the table shown in FIG. 7.

FIG. 7 indicates that feature 510 is associated with the feature type speed limit sign, a (normalized) parameter range 530 of 0.00 to 0.25, and a confidence score of 0.2. As can be seen in FIG. 5, the parameter range 530 of 0.00 to 0.25 indicates that the feature 510 is located between a first end of the road segment 500 and a point a quarter of the length along the road segment 500. According to the model corresponding to the one or more characteristics of road segment 500, the feature weight for a feature associated with the feature type speed limit sign and a confidence type corresponding to the confidence score of 0.2 for feature 510 is high. While the feature weight shown in FIG. 7 is categorical (e.g., high, medium, low) various other feature weight schemes may be used in various embodiments, such as numerical feature weights, and/or the like.

Starting at block 602 of FIG. 6, discretized parameter ranges are defined based on the feature data. For example, the network apparatus 10 and/or the mobile apparatus 20 defines discretized parameter ranges based on the feature data. For example, the network apparatus 10 and/or the mobile apparatus 20 comprises means, such as processor 12, 22, memory 14, 24, and/or the like for defining discretized parameter ranges based on the feature data.

FIG. 8 provides a table illustrating the defined discretized parameter ranges for the road segment 500 and the features shown in FIG. 5 and described in FIG. 7. For example, for the parameter ranges 530, 532, corresponding to features 510, 512 are both present in the discretized range 0.00 to 0.10. However, feature 514 is associated with parameter range 534 from 0.10 to 0.20. Thus, a second discretized parameter range is defined from 0.10 to 0.20. In particular, the discretized parameter ranges are defined such that any parameter range of one of the features in the feature data overlaps completely with one or more discretized parameter ranges. For example, the parameter range 530 overlaps completely with discretized parameter ranges 0.00 to 0.10, 0.10 to 0.20, and 0.20 to 0.25. For example, the discretized parameter ranges do not include any ranges that are only partially overlapped by a parameter range of one of the features.

Continuing to block 604 of FIG. 6, the most relevant feature associated with each discretized parameter range is determined. For example, the network apparatus 10 and/or mobile apparatus 20 determines the most relevant feature associated with each discretized parameter range For example, the network apparatus 10 and/or mobile apparatus 20 comprises means, such as processor 12, 22, memory 14, 24, and/or the like for determining the most relevant feature associated with each discretized parameter range.

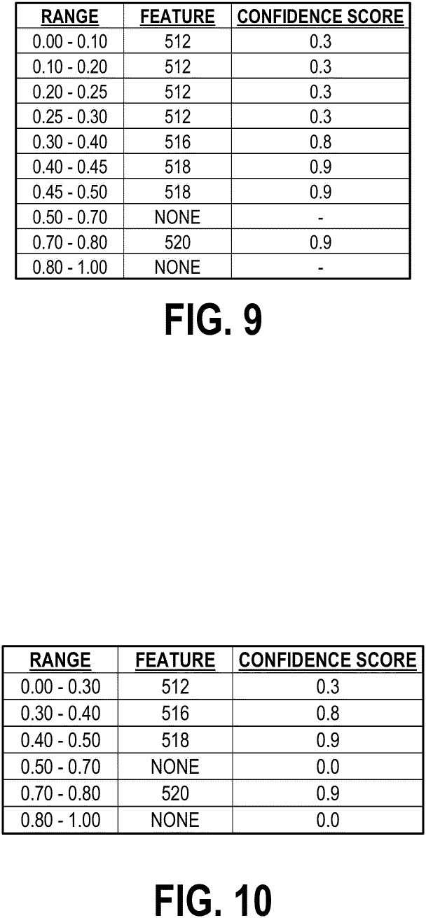

For example, FIG. 9 provides a table that indicates the respective most relevant feature for each of the discretized parameters ranges. The most relevant feature for a discretized parameter range is the feature within the discretized parameter range that is associated with the feature weight indicating the highest relevancy for automated operation of a vehicle along the road segment 500. When there are multiple features associated with a feature weight indicating the highest relevancy for automated operation of a vehicle along the road segment, the feature associated with the highest relevancy and having the highest confidence level is selected as the most relevant feature for the discretized parameter range. For example, FIG. 8 shows that both feature 510 and feature 512 are associated with the discretized parameter range 0.00 to 0.10 and are both associated with a feature weight of high. However, feature 510 has a confidence level of 0.2 and feature 512 has a confidence level of 0.3. Thus, feature 512 is selected and/or determined as the most relevant feature for the discretized parameter range 0.00 to 0.10, as shown in FIG. 9.

Continuing with block 606 of FIG. 6, the continuous parameter range intervals are compiled from adjacent discretized parameter ranges having the same most relevant feature. For example, the network apparatus 10 and/or mobile apparatus 20 compiles adjacent discretized parameter ranges having the same most relevant feature to form and/or define the continuous parameter range intervals. For example, the network apparatus 10 and/or mobile apparatus 20 comprises means, such as processor 12, 22, memory 14, 24, and/or the like for compiling adjacent discretized parameter ranges having the same most relevant feature to form and/or define the continuous parameter range intervals.

For example, FIG. 10 provides a table showing the results of compiling the adjacent discretized parameter ranges from the table in FIG. 9 that have the same most relevant feature. For example, comparing the tables of FIG. 9 and FIG. 10, one can see that the feature 512 was selected and/or determined to be the most relevant feature in discretized parameter ranges 0.00 to 0.10, 0.10 to 0.20, 0.20 to 0.25, and 0.25 to 0.3. As these discretized parameter ranges are adjacent to one another and/or consecutive, they are compiled into the continuous parameter range interval 0.30. Once the continuous parameter range intervals are compiled, as shown in FIG. 10, the one or more aggregate confidence scores are determined therefrom.

### III. Technical Advantages

Various embodiments enable the determination of aggregate confidence scores for road segments based on the relevancy and/or importance of different types of features and/or different types of confidence scores to the automated operation of a vehicle along the road segments. For example, based on the tables provided in FIGS. 8 and 9, one can see that feature 514 has the highest confidence score in the discretized parameter range 0.10 to 0.20. However, feature 512 is selected as the most relevant feature for the discretized parameter range 0.10 to 0.20 because the feature 514 is of a feature type that is not particularly helpful or important for automated navigation of a vehicle along the road segment 500, which has the characteristic of road functional class highway. Thus, the resulting aggregate confidence score is a more accurate representation of the confidence with which a vehicle can be operated in an automated fashion along the road segment 500 (compared to blindly selecting feature 514 as the most relevant feature for discretized parameter range 0.10 to 0.20 because the confidence score is higher). Thus, various embodiments provide for a more accurate determination of map-enabled driving scenarios for a road segment.

In various embodiments, the feature weights are defined based on user input. This enables the feature weights to reflect and/or take advantage of known sensor response characteristics, behaviors, and/or response to different situations (e.g., tie varying situations such as weather, time of day as such affects ambient lighting, and/or the like); known object type frequency along road segments of various road functional classes and/or geographic settings; known object distinctiveness; enabling manipulation and/or modification of feature weights in order to increase reliability of determined aggregate confidence score(s) and/or map-enabled driving scenario(s); and/or the like. Thus, in various embodiments, the feature weights are configured to enable a more reliable determination of aggregate confidence scores and map-enabled driving scenarios for various road segments based on characteristics of the road segment.

By enabling a more accurate determination of map-enabled driving scenarios for a road segment, various embodiments reduce the need for human override (e.g., when a route is selected to be an automated operation route and/or to reduce the need for urgent human override when traversing a road segment where the aggregate confidence score was not accurate.

Thus, various embodiments provide an improvement to the technical art of automated vehicle operation and/or determining when automated vehicle operation is appropriate by providing a technical solution that enables a more accurate aggregate confidence score to be determined for a road segment based on characteristics of the road segment.

### IV. Example Apparatus

The network apparatus 10 and/or mobile apparatus 20 of an example embodiment may be embodied by or associated with a variety of computing devices including, for example, a navigation system including an in-vehicle navigation system, a vehicle control system, a personal navigation device (PND) or a portable navigation device, an advanced driver assistance system (ADAS), a global navigation satellite system (GNSS), a cellular telephone, a mobile phone, a personal digital assistant (PDA), a watch, a camera, a computer, and/or other device that can perform navigation-related functions, such as digital routing, map display, automated operation of a vehicle, and/or the like. Additionally or alternatively, the network apparatus 10 and/or mobile apparatus 20 may be embodied in other types of computing devices, such as a server, a personal computer, a computer workstation, a laptop computer, a plurality of networked computing devices or the like, that are configured to maintain and/or update one or more map tiles of a digital map, analyze map data for route planning or other purposes, and/or the like. In an example embodiment, a mobile apparatus 20 is an in-vehicle navigation system onboard a vehicle 5 or a mobile device (e.g., a user device such as a smartphone, tablet, and/or the like) and a network apparatus 10 is a server, and/or the like. In this regard, FIG. 2A depicts an example network apparatus 10 and FIG. 2B depicts an example mobile apparatus 20 that may be embodied by various computing devices including those identified above. As shown, the network apparatus 10 of an example embodiment may include, may be associated with, or may otherwise be in communication with a processor 12 and a memory device 14 and optionally a communication interface 16 and/or a user interface 18. Similarly, a mobile apparatus 20 of an example embodiment may include, may be associated with, or may otherwise be in communication with a processor 22 and a memory device 24 and optionally a communication interface 26, a user interface 28, one or more sensors 29 (e.g., a location sensor such as a GNSS sensor, IMU sensors, and/or the like; camera(s); 2D and/or 3D LiDAR(s); long, medium, and/or short range RADAR; ultrasonic sensors; electromagnetic sensors; (near-)IR cameras, 3D cameras, 360° cameras; and/or other sensors that enable the probe apparatus to determine one or more features of the corresponding vehicle’s 5 surroundings), and/or other components configured to perform various operations, procedures, functions, or the like described herein.

In some embodiments, the processor 12, 22 (and/or co-processors or any other processing circuitry assisting or otherwise associated with the processor) may be in communication with the memory device 14, 24 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network apparatus 10 and/or mobile apparatus 20 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22 may be embodied in a number of different ways. For example, the processor 12, 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22, 32 may include one or more processing cores configured to perform independently. A multi-core processor may enable multiprocessing within a single physical package. Additionally or alternatively, the processor 12, 22 may include one or more processors configured in tandem via the bus to enable independent execution of instructions, pipelining and/or multithreading.

In an example embodiment, the processor 12, 22 may be configured to execute instructions stored in the memory device 14, 24 or otherwise accessible to the processor. For example, the processor 22 may be configured to execute computer-executable instructions configured to cause control of the automated operation of an associated vehicle 5 in accordance with a determined map-enabled driving scenario. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network apparatus 10 and/or mobile apparatus 20 may include a user interface 18, 28 that may, in turn, be in communication with the processor 12, 22 to provide output to the user, such as one or more potential DFC corridors and the corresponding rankings, and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22 (e.g., memory device 14, 24, and/or the like).

The network apparatus 10 and/or mobile apparatus 20 may optionally include a communication interface 16, 26. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In addition to embodying the network apparatus 10 and/or mobile apparatus 20 of an example embodiment, a navigation system may also include or have access to a geographic database that includes a variety of data (e.g., map information/data, at least a portion of a lane level network graph representing at least a portion of the traversable network) utilized in constructing a route or navigation path, determining the time to traverse the route or navigation path, matching a geolocation (e.g., a GNSS determined location) to a point on a map, a lane of a lane network, and/or link, and/or the like. For example, a geographic database may include a lane level network graph and/or portion thereof, lane data records, road segment or link data records, point of interest (POI) data records and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, lane data records, POI data records, and/or other data records. In an example embodiment, the network apparatus 10 may be configured to modify, update, and/or the like one or more data records of the geographic database. For example, the network apparatus 10 may modify, update, generate, and/or the like a lane level network graph and/or the corresponding data records, a localization layer (e.g., comprising feature data) and/or the corresponding data records, and/or the like.

In an example embodiment, the connection information/data and/or road segment data records are links or segments, e.g., maneuvers of a maneuver graph, representing roads, streets, or paths, as can be used in the calculated route or recorded route information for determination of one or more personalized routes. The intersection data records are end points corresponding to the respective links or segments of the road segment data records. The road link data records and the intersection data records represent a traversable network, such as used by vehicles, cars, pedestrians, bicyclists, and/or other entities. Similarly, the nodes and connection information/data of the lane level network graph represent a lane network, such as used by vehicles, cars, and/or other entities. Alternatively, the geographic database can contain path segment and intersection data records or nodes and connection information/data or other data that represent pedestrian paths or areas in addition to or instead of the vehicle road record data, for example.

The road/link segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used. In an example embodiment, the geographic database (e.g., the lane level network graph) may be generated and/or updated based on information/data provided by a plurality of non-dedicated probe apparatuses. For example, the probe apparatuses may be onboard vehicles owned and/or operated by and/or on behalf of members of the general public such that, for example, new drives used to generate and/or update the lane level network graph may be crowdsourced.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, a navigation system that embodies a network apparatus 10 and/or mobile apparatus 20 in accordance with an example embodiment may determine the time to traverse a route that includes one or more turns at respective intersections more accurately.

### IV. Apparatus, Methods, and Computer Program Products

As described above, FIGS. 3, 4, and 6 illustrate flowcharts of a network apparatus 10 and/or mobile apparatus 20, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24 of an apparatus employing an embodiment of the present invention and executed by the processor 12, 22 of the respective apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining, by one or more processors, one or more aggregate confidence scores for a road segment; and
based at least in part on the confidence score, determining, by one or more processors, a map-enabled driving scenario for the road segment,
wherein determining the confidence score for the road segment comprises:
obtaining feature weights corresponding to one or more characteristics of the road segment, wherein a respective feature weight (a) is associated with at least one of a respective feature type or a respective confidence type and (b) indicates a relevancy measure of the associated respective feature type;
obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located;
based on (a) the respective parameter range indicator and the respective feature type of each instance of feature data and (b) the feature weights, defining continuous parameter range intervals along the road segment;
assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and
determining the one or more aggregate confidence scores for the road segment based at least in part on each of the respective interval confidence scores.

2. The method of claim 1, wherein the map-enabled driving scenario for the road segment indicates at least one of (a) whether autonomous vehicle operation is enabled along the road segment or (b) a level of autonomous vehicle operation that is enabled along the road segment.

3. The method of claim 1, wherein assigning the respective interval confidence score to each continuous parameter range interval along the road segment comprises:
identifying one or more instances of feature data each comprising a respective parameter range indicator associated with the respective continuous parameter range interval;
determining, based at least in part on (a) the feature weights and (b) at least one of the respective confidence type or the respective feature type of the one or more instances of feature data, the most relevant feature associated with the respective continuous parameter range interval; and
determining, based on the at least one confidence score associated with the most relevant feature, the respective interval confidence score.

4. The method of claim 3, wherein determining the most relevant feature associated with the respective continuous parameter range interval comprises determining a relevancy measure for the respective features located within the respective continuous parameter range interval.

5. The method of claim 1, wherein the road segment type is determined based at least in part on at least one of (a) a road functional class associated with the road segment or (b) a geographic setting associated with the road segment.

6. The method of claim 1, wherein the feature weights are determined by at least one of (a) a machine learning trained model or (b) user input.

7. The method of claim 1, further comprising causing a corresponding vehicle to be operated along at least a portion of the road segment in accordance with the map-enabled driving scenario.

8. The method of claim 1, further comprising causing a user interface to visually or audibly provide an indication of the map-enabled driving scenario.

9. An apparatus comprising at least one processor, a communications interface configured for communicating via at least one network, and at least one memory storing computer program code, the at least one memory and the computer program code configured to, with the processor, cause the apparatus to at least:
determine one or more aggregate confidence scores for a road segment; and
based at least in part on the confidence score, determine a map-enabled driving scenario for the road segment,
wherein determining the confidence score for the road segment comprises:
obtaining feature weights corresponding to one or more characteristics of the road segment, wherein a respective feature weight (a) is associated with at least one of a respective feature type or a respective confidence type and (b) indicates a relevancy measure of the associated respective feature type;
obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located;
based on (a) the respective parameter range indicator and the respective feature type of each instance of feature data and (b) the feature weights, defining continuous parameter range intervals along the road segment;
assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and
determining the one or more aggregate confidence scores for the road segment based at least in part on each of the respective interval confidence scores.

10. The apparatus of claim 9, wherein the map-enabled driving scenario for the road segment indicates at least one of (a) whether autonomous vehicle operation is enabled along the road segment or (b) a level of autonomous vehicle operation that is enabled along the road segment.

11. The apparatus of claim 9, wherein assigning the respective interval confidence score to each continuous parameter range interval along the road segment comprises:
identifying one or more instances of feature data each comprising a respective parameter range indicator associated with the respective continuous parameter range interval;
determining, based at least in part on (a) the feature weights and (b) at least one of the respective confidence type or the respective feature type of the one or more instances of feature data, the most relevant feature associated with the respective continuous parameter range interval; and
determining, based on the at least one confidence score associated with the most relevant feature, the respective interval confidence score.

12. The apparatus of claim 11, wherein determining the most relevant feature associated with the respective continuous parameter range interval comprises determining a relevancy measure for the respective features located within the respective continuous parameter range interval.

13. The apparatus of claim 9, wherein the road segment type is determined based at least in part on at least one of (a) a road functional class associated with the road segment or (b) a geographic setting associated with the road segment.

14. The apparatus of claim 9, wherein the feature weights are determined by at least one of (a) a machine learning trained model or (b) user input.

15. The apparatus of claim 9, wherein the at least one memory and the computer program code are further configured to, with the processor, cause the apparatus to at least cause a corresponding vehicle to be operated along at least a portion of the road segment in accordance with the map-enabled driving scenario.

16. The apparatus of claim 9, wherein the at least one memory and the computer program code are further configured to, with the processor, cause the apparatus to at least cause a user interface to visually or audibly provide an indication of the map-enabled driving scenario.

17. A computer program product comprising at least one non-transitory computer-readable storage medium having computer-readable program code portions stored therein, the computer-readable program code portions comprising executable portions configured, when executed by a processor of an apparatus, to cause the apparatus to:
determine one or more aggregate confidence scores for a road segment; and
based at least in part on the confidence score, determine a map-enabled driving scenario for the road segment,
wherein determining the confidence score for the road segment comprises:
obtaining feature weights corresponding to one or more characteristics of the road segment, wherein a respective feature weight (a) is associated with at least one of a respective feature type or a respective confidence type and (b) indicates a relevancy measure of the associated respective feature type;
obtaining instances of feature data associated with the road segment, wherein each instance of feature data comprises (a) at least one respective confidence score associated with a respective confidence type for a respective feature located along the road segment, (b) the respective feature type corresponding to the respective feature, and (c) a respective parameter range indicator configured to indicate where along the road segment the respective feature is located;
based on (a) the respective parameter range indicator and the respective feature type of each instance of feature data and (b) the feature weights, defining continuous parameter range intervals along the road segment;
assigning a respective interval confidence score to each continuous parameter range interval along the road segment based on a respective most relevant feature, the respective most relevant feature corresponding to an instance of feature data comprising a respective parameter range indicator associated with the respective continuous parameter range interval and comprising the respective feature type associated with the most relevant relevancy measure of respective features located within the respective continuous parameter range interval; and
determining the one or more aggregate confidence scores for the road segment based at least in part on each of the respective interval confidence scores.

18. The computer program product of claim 17, wherein the map-enabled driving scenario for the road segment indicates at least one of (a) whether autonomous vehicle operation is enabled along the road segment or (b) a level of autonomous vehicle operation that is enabled along the road segment.

19. The computer program product of claim 17, wherein the road segment type is determined based at least in part on at least one of (a) a road functional class associated with the road segment or (b) a geographic setting associated with the road segment.

20. The computer program product of claim 17, wherein the computer-readable program code portions comprising executable portions further configured, when executed by a processor of an apparatus, to cause the apparatus to perform at least one of:
(a) cause the apparatus to at least cause a corresponding vehicle to be operated along at least a portion of the road segment in accordance with the map-enabled driving scenario, or
(b) cause the apparatus to at least cause a user interface to visually or audibly provide an indication of the map-enabled driving scenario.
